(19) United States
(12) Patent Application Publication
(10) Pub. No.: US 2016/0342381 A1
(43) Pub. Date: Nov. 24, 2016

(54) NETWORK AUDIO SYSTEM

(71) Applicant: Sugr Electronics Corp., Plano, TX (US)

(72) Inventor: Shaopeng Song, Shenzhen (CN)

(73) Assignee: Sugr Electronics Corp.

(21) Appl. No.: 14/742,317

(22) Filed: Jun. 17, 2015

(30) Foreign Application Priority Data
May 20, 2015 (CN) 2015201251064

(51) Int. Cl. G06F 3/16; G06K 7/10

(52) U.S. Cl. CPC G06F 3/165; G06K 7/10336; G06K 7/10297

(57) ABSTRACT

A network audio system includes a housing for the speaker, a radio frequency identification (“RFID”) reader in or attached to said housing for detecting and reading one or more electronic tags in an external chip, a network adapter in or attached to said housing for downloading one or more audio files according to said electronic tags via a network, and an audio play module in or attached to said housing for decoding and playing said one or more audio files. This new type of network audio system controls the play of audio files by using an RFID reader and an external chip such as a RFID card or NFC card. It is easy to control and less susceptible to damages than existing networked speaker systems. It provides a new dimension to control network speakers without using any smartphone or tablet, this is helpful for children or senior people.

### TECHNICAL FIELD

The inventions disclosed herein generally relate to the field of network audio systems, more specifically a network speaker system.

### BACKGROUND OF THE INVENTION

We have witnessed an explosion of new consumer electronic products invented in the last decade. More people use smart phones, tablets, and networked speakers in their daily life. As a relatively less complicated electronic product, network audio systems or speakers have become popular for their better fit to meet consumers' needs for enjoying music and other audio resources in the Internet.

Existing network speakers, however, are generally controlled through an external device such as a smart phone or a tablet PC. Alternatively, some has a hardware control module installed inside or attached to the speaker's housing. The additional hardware component makes it difficult to have a simplified modern design for the speaker system. Such systems are also susceptible to accidental damages or easily worn out.

Therefore great needs exist for a network audio system that can solve the above-mentioned issues.

### SUMMARY OF THE INVENTION

The object of the present inventions is to provide a network audio system that is easy to operate and control. Such system is also less susceptible to damages to the audio control component that are common in existing audio systems.

Another object of the present inventions is a network audio system that includes a housing, a radio frequency identification (“RFID”) reader in or attached to said housing for detecting and reading one or more electronic tags in an external chip, a network adapter in or attached to said housing for downloading one or more audio files according to said electronic tags via a network, and an audio play module in or attached to said housing for decoding and playing said one or more audio files.

Another object of the present inventions is a network audio system that further includes one or more fixtures through which the external chip can be detachably attached to the housing of the speaker. The fixture can be made of or include either a magnetic component or a metal component. The external chip can made of or include either a metal component or a magnetic component so that the external chip can be attached to the housing through magnetic attraction.

Another object of the present inventions is to provide a network audio system where an external chip is made as a mesh enclosure for the speaker housing. The enclosure is either magnetic or metal so it could be easily attached to the housing.

Another object of the present inventions is to provide a network audio system where the external chip that is either a wireless RFID card or a wireless near field communication (“NFC”) card.

Another object of the present inventions is to provide a network audio system where the RFID reader further comprises an electronic tag reader and an antenna. The antenna could be located at the forefront, top, left side, right side, or other proper location of the housing. The housing may include a label close to said antenna identifying the area to place an external chip.

Another object of the present inventions is to provide a network audio system that further comprises a wireless network adapter.

Another object of the present inventions is to provide a network audio system that further includes a remotely located network server wherein said network sever includes a decoder to decode electronic tags and identify the corresponding audio files, and a network transport module for sending said audio files to said network adapter.

Another object of the present inventions is to provide a network audio system where the network adapter downloads audio files through the Internet. Alternatively, it could download the audio files through a local intranet or internal network.

Comparing to existing network speakers, the present systems use a RFID reader and an external chip or card to control the play of music or other audio file. It's much easier to control music play and less susceptible to damages of a control module common in existing network speakers.

### BRIEF DESCRIPTION OF THE DRAWINGS

FIG. 1 is a structural illustration of one preferred embodiment of the present inventions;

FIG. 2 is a structural illustration of the RFID reader in one preferred embodiment of the present inventions;

FIG. 3 is a structural illustration of a network server in one preferred embodiment;

FIG. 4A is an illustration of the use of a network audio system in one preferred embodiment:

FIG. 4B is another illustration of the network audio system shown in FIG. 4A;

FIG. 5A depicts the use of a network audio system in one preferred embodiment;

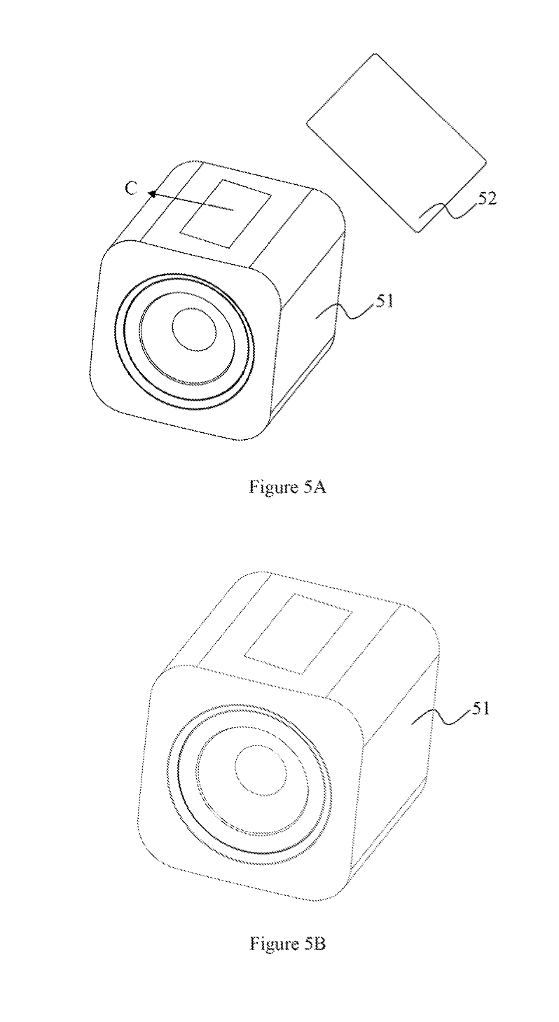

FIG. 5B is another illustration of the network audio system shown in FIG. 5A; Before proceeding, the labels in the figures are identified as follows:
10—A network audio system;
11—Housing;
12—Wireless RFID reader;
121—An electronic tag reader;
122—An antenna;
13—Network adapter;
14—Audio play module;
15—External chip;
16—Network server;
161—Decoder;
162—Network transport module;
41—Housing;
42—Metal mesh enclosure
51—Housing;
52—External chip;

### DETAILED DESCRIPTION

The following are the detailed description of the various preferred embodiments as illustrated in the figures. The directional terms used herein, e.g., top, bottom, front, back, left, right, inside, outside, and side etc., are for illustrational purpose only. They are used to better describe the relevant figures but not in any means to limit the scope of the present inventions.

FIG. 1 depicts a structural illustration of one preferred embodiment of the present network audio system. In this example, the network speaker system 10 includes housing 11. Inside the housing 11 includes at least one wireless RFID reader 12; a wireless network adapter 13 and audio play module 14. The wireless RFID reader 12 is configured to read the electronic signal tag in an external chip 15. The network adapter 13 is configured to download the corresponding audio file(s) according to the tag from a network server 16. The network adapter is preferred to be a wireless network adapter or other compatible ones. The audio play module 14 is configured to decode and play the audio files.

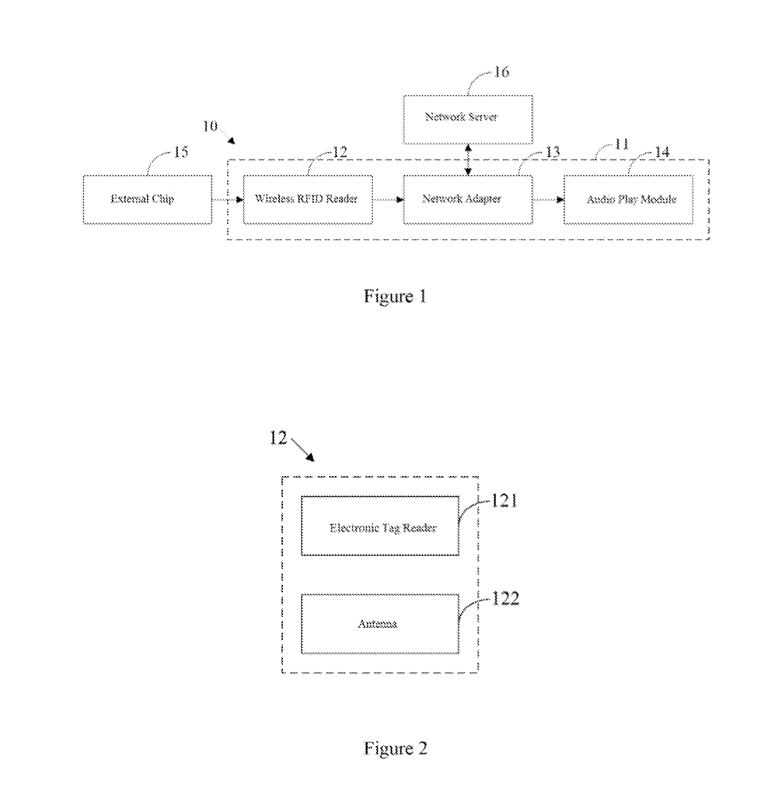

FIG. 2 depicts a structural illustration of a RFID reader in one preferred embodiment of the present inventions. The wireless RFID reader 12 includes a fixed tag reader 121 and a receiver antenna 122. The tag reader 121 is configured to receive and read the electronic tag that the antenna 122 received from the external chip 15.

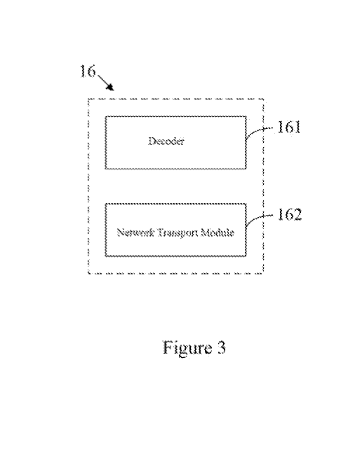

FIG. 3 depicts a structural illustration of a network server in one preferred embodiment. The network server 16 is a computer server that includes at least a decoder 161 and a network transport module 162.

A preferred embodiment of the network audio system 10 functions as the following:

First, a user temporarily put an external chip 15 next to a RFID reader located inside the housing 11. A fixed electronic tag reader 121 then reads the tag in external chip 15 through the antenna 122. After one or more tags are detected and received, a network adapter 13 retrieves the tag from the RFID reader and sends it to a corresponding network server 16. Network server 16 includes a decoder 161 which is capable of decoding the received electronic tag and determining the corresponding audio files based on the decoded tag. The identified audio file could be music, audio book or network radio programs etc. The network transport module 162 will then send the audio file retrieved by the decoder 161 through the network to the play module 14 in the network audio system 10. The audio play module 14 will then decode the audio file sent by the network server and play it accordingly.

The play of audio files does not require direct control by the user. Neither does it require a smart phone or other devices to indirectly control the play of the corresponding audio files. It's all controlled and operated automatically through the user of an external chip. The selection of an external chip determines the selection and play of desired audio files. Moreover, the audio files are generally not locally stored at the network audio system, which saves disk space in the audio system. The play of audio files is simple as placing an external chip close to the RFID reader. Such designs are not susceptible to damages to a physical control module (e.g., buttons or other control mechanisms) when frequently operated by a user. The requirements for the design of a control module are simplified. The overall design of the network audio system is more sleek and concise.

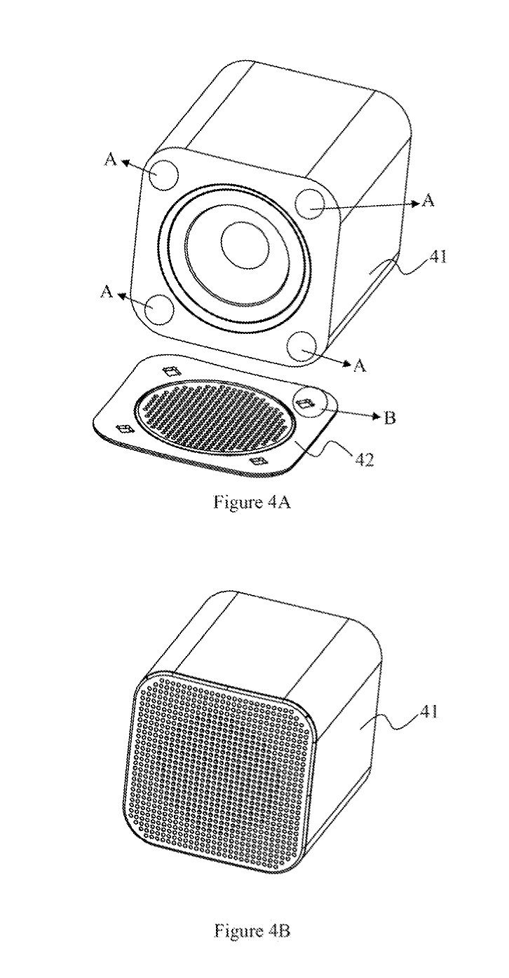

The following are two other preferred embodiments of the present inventions. FIG. 4A is a first illustration of the use of a preferred network audio system. FIG. 4B is the second illustration showing the use of the system depicted in FIG. 4A.

As shown in FIG. 4A, the surface of the housing 41 includes a fixture at each area marked as “A.” In this example, the figure is made of or includes a magnetic component. The fixtures could be attached to the inside or outer surface of the housing 41. The external chip is made of a metal mesh enclosure 42. There is at least one fixture at each area marked as “B” on the mesh enclosure 42. The fixtures on the mesh enclosure 42 are either made of or include a metal component. Through the attraction between a metal component and a magnetic component, the mesh enclosure 42 can be detachably set on one side surface of the housing 41. Therefore, the RFID reader (not depicted in FIG. 4A) inside the housing 41 can easily read the electronic tag in the mesh enclosure 42. The network adapter (not depicted in FIG. 4A) in housing 41 then downloads the corresponding audio file based on the electronic tag from a network server.

There are many other ways to attach the mesh enclosure 42 to the housing 41. For example, one could glue the mesh enclosure 42 to housing 41. Others could screw the mesh enclosure to housing 41. Additionally, a maker of the mesh enclosure 42 could print information about the corresponding audio file on the enclosure itself. For example, mesh enclosure that includes a tag for a Michael Jackson song could have a portrait of the singer printed on the mesh enclosure.

FIGS. 5A and 5B are illustrations of the use of a network audio system in another preferred embodiment. FIG. 5A is a first illustration and FIG. 5B is the second illustration of the same preferred embodiment.

Referring to Figure SA, there is no fixture on the surface of the housing 51. In this preferred embodiment, the receiver antenna of the RFID reader is located at the top of the housing 51. On the corresponding top surface of the housing 51 and close to the antenna, there is a label identifying an area “C” where a user can place or swipe an external RF chip or card. Of course the receiver antenna could also be located at the forefront, left side, right side, or other areas of the hosing 51. An external chip 52 could be a RFID card, or a NFC card. Or it could be any other external card capable of storing one or more electronic tags. To use the network speaker system, a user just place an external chip 52 on the area marked as “C.” The wireless RFID reader (not depicted) can readily detect and retrieve the electronic tag in the external chip 52. The electronic tag is then used by the network adapter (not depicted) in the housing 51 to download the corresponding audio files from the network. The network could be intranet or extra network like the Internet.

Once the audio system starts playing the downloaded audio files, a user can remove the external chip 52 as shown in Figure SB. The external chip 52 could be made of many shape or material. For example, it could be shaped as a key chain, a magnetic swipe card or optic disc etc.

Although several exemplary embodiments of the present inventions have been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

1. A network speaker system comprising:
a housing designed as a portable speaker;
a radio frequency identification (“RFID”) reader located within said housing for detecting and reading one or more electronic tags in an external chip;
a network adapter located within said housing for automatically downloading one or more audio files according to said electronic tags via a network;
an audio play module located within said housing for automatically decoding and playing said one or more audio files and said audio play module is automatically controlled by said electronic tag information received by the RFID reader;
one or more fixtures through which said external chip can be detachably attached to said housing;
wherein said RFID reader, network adapter, and audio play module are integrated inside said housing, and
wherein said one or more audio files are downloaded on demand and not permanently stored by said audio play module.

2. (canceled)

3. A network speaker system of claim 1 wherein said fixture includes a magnetic component and said external chip includes a metal component.

4. A network speaker system of claim 1 wherein said fixture includes a metal component and said external chip includes a magnetic component.

5. A network speaker system of claim 1 wherein said external chip is a metal mesh enclosure that can be attached said housing.

6. A network speaker system of claim 4 wherein said external chip is a magnetic mesh enclosure that can be attached to said housing.

7. A network speaker system of claim 1 wherein said external chip is a wireless RFID card or a wireless near field communication (“NFC”) card.

8. A network speaker system of claim 1 wherein said RFID reader further comprises an electronic tag reader and an antenna.

9. A network speaker system of claim 8 wherein said antenna is located at the forefront, top, left side, or right side of said housing.

10. A network speaker system of claim 8 wherein said housing further comprises a label close to said antenna identifying the area to place said external chip.

11. A network speaker system of claim 1 wherein said network adapter is a wireless network adapter.

12. A network speaker system of claim 1 further comprises a remotely located network server wherein said network sever includes a decoder to decode said electronic tags and identify the corresponding audio files; and a network transport module for sending said audio files to said network adapter.

13. A network speaker system of claim 1 wherein said network is the Internet.
